(19) United States
(12) Patent Application Publication
(10) Pub. No.: US 2013/0118073 A1
(43) Pub. Date: May 16, 2013

(54) SOILLESS PLANT CULTIVATION SYSTEM

(71) Applicants: David Kondracki, Russellville, KY (US); David Pelgrims, Chatham (CA); William Wu, Windsor (CA); Colby Wu, Windsor (CA)

(72) Inventors: David Kondracki, Russellville, KY (US); David Pelgrims, Chatham (CA); William Wu, Windsor (CA); Colby Wu, Windsor (CA)

(73) Assignee: STRATUS HYDROPONICS INTERNATIONAL, INC., Windsor (CA)

(21) Appl. No.: 13/296,595

(22) Filed: Nov. 15, 2011

(51) Int. Cl. A01G 31/02; A01G 31/00

(52) U.S. Cl. 47/62 C; 47/59 R

(57) ABSTRACT

A modular soilless garden system for supporting a plant root cultivation medium (such as a substratum mat) is described. The system includes a platform with a subsurface temperature regulation network. The network facilitates passage of a gas or a liquid to regulate the temperature of the plant roots hosted in the cultivation medium. A plurality of foundations connect end to end to form the platform. Two circulation manifolds connect to the terminal ends of the platform to interconnect the distinct subsurface fluid passages.

### FIELD OF THE INVENTION

The present invention relates to the soilless cultivation of plants, and more particularly to a support and a system for supporting a root host.

### BACKGROUND OF THE INVENTION

Soilless cultivation is a method of growing plants including agricultural crops and ornamental plants using water and nutrients. The plants are typically grown with their roots in an inert medium or in a nutrient solution. In some applications, the plants are grown with their roots in a substrate of fibrous or granular material such as gravel or mineral wool saturated in a nutrient bearing material.

Soilless cultivation may be used in environments that are adverse to soil based cultivation because of deficiencies in the soil, lack of land or an unsuitable climate. Soilless gardens may be established indoors (such as in green houses) where climate, temperature, moisture and other environmental factors can be tightly controlled. Soilless gardens can produce increased yields and allow better quality control than soil based production.

Hydroponic gardens are conventionally cultivated by suspending plant roots in a nutrient solution. The nutrient solution may be circulated about a network of plants or provided in a bath which the plant roots are submerged. In both instances, the plant is commonly supported at its base so that the foliage is exposed to a suitable environment.

Another soilless gardening system involves hosting the plants roots in an inert medium (such as sand, gravel or a fibrous mat) and delivering a regular supply of nutrients in solution. Often the inert medium that supports the plant roots is housed in a container (such as a pot) that can be easily drained of excess solution.

### SUMMARY OF THE INVENTION

According to some embodiments, the present invention relates to a modular soilless garden system including:

a plurality of foundations that connect end to end to form a support platform for a root host, each foundation including an upper surface that forms part of the support platform when assembled and a plurality of distinct fluid passages that extend between the connecting ends of each foundation and interconnect with the fluid passages of adjacent foundations when the system is assembled, the fluid passages being disposed below the support surface of each foundation, and

two circulation manifolds that connect to opposing terminal ends of an assembled platform to interconnect the distinct fluid passages into a temperature regulation network, the manifolds defining an inlet and an outlet for the temperature regulation network that connects to an auxiliary temperature regulation system, the temperature regulation network being substantially sealed between inlet and the outlet.

In some embodiments, the present invention further relates to a soilless garden foundation including:

a support structure having opposed connecting ends that facilitate interconnection with other components of a soilless garden system, the support structure having a generally planar upper surface that extends between the opposed connecting ends to define a root host support, and

a plurality of fluid passages integral with the support structure, each fluid passages having an inlet disposed at one connecting end of the support structure, an outlet disposed at another connecting end of the support structure and a lumen that extends between the inlet and the outlet below the upper surface, the lumen defining a sealed passageway below the upper surface of the support structure between the inlet and the outlet.

In other embodiments, the present invention further relates to a modular soilless garden system including:

a plurality of foundations that interconnect to form a support platform for a root host, each foundation having a support surface and a plurality of fluid passages that extend below the support surface, the fluid passages of adjacent foundations connecting together in temperature regulation networks when the system is assembled, and

two circulation manifolds that engage terminal ends of an assembled system to interconnect distinct temperature regulation networks into a substantially sealed platform temperature regulation loop, the manifolds including an inlet and an outlet for connection to an auxiliary fluid circulation system.

In another embodiment, the present invention relates to a method of regulating plant root temperature including the steps of:

hosting plant roots in an inert medium,

supporting the inert root host medium on a platform, the root host medium being disposed on a support surface of the platform so that the platform and the root host medium are coupled by a thermal conduction pathway,

passing a temperature regulating fluid below the upper surface of the platform, the temperature regulating fluid being directed through passages that are coupled to the upper surface of the platform by a thermal conduction pathway so that heat can transfer conductively between the plant roots and the temperature regulating fluid, and regulating the fluid temperature based on the desired plant root temperature.

The term ‘fluid’, as used in this specification (including the claims) should be construed as meaning any state of matter which can flow with relative ease and tends to assume the shape of its container, including a liquid, gas or plasma.

### BRIEF DESCRIPTION OF THE DRAWINGS

Embodiments of the invention will be described by way of example and with reference to the drawings in which:

FIG. 1 is a perspective view of an assembled modular soilless garden system including a plurality of foundations interconnected in a support platform for an inert cultivation medium.

FIG. 2 is front elevation of the soilless garden system illustrated in FIG. 1 illustrating a fluid distribution manifold connected to one end. The manifold has a central large bore inlet flanked by two smaller bore side outlets. The fluid passage openings of the foundation are evident through the inlet and the outlets.

FIG. 3 is a top elevation of the soilless garden system illustrated in FIGS. 1 and 2. A plurality of reinforcing ribs are evident protruding through the upper surface of the platform are evident.

FIG. 4 is a side elevation of the soilless garden system illustrated in FIGS. 1 to 3. A coupling sleeve is illustrated overlaping the junction between adjacent foundations.

FIG. 5 is a close up front perspective view of the distribution manifold illustrated in FIGS. 1 to 4 showing the position of the foundation fluid passages through the manifold inlet and one of the side outlets.

FIG. 6 is a front elevation of a foundation showing the fluid passages that extend below the upper surface. The upper surface reinforcing ribs are also evident.

FIG. 7 is a perspective view of an assembled platform illustrating the coupling sleeve that overlaps the junction of adjacent foundations.

FIG. 8 is a perspective view of a coupling sleeve connected to the end of a foundation. The foundation fluid passages are evident in the illustration.

FIG. 9 is a perspective view of coupling sleeve illustrating a plurality of notches in the upper surface that accommodate the foundation reinforcing ribs.

FIG. 10 is perspective view of a gasket that is disposed in the coupling sleeve to seal adjacent fluid passages.

FIG. 11 is a perspective view of an alternate form of soilless garden root host support.

FIG. 12 is a perspective view of another embodiment of soilless garden support.

FIG. 13 is a perspective view of a nutrient distribution manifold for a soilless garden support.

FIG. 14 is a perspective view of the manifold illustrated in FIG. 13.

FIG. 15 is a perspective view of another embodiment of soilless garden support.

FIG. 16 is a perspective view of the support illustrated in FIG. 15.

FIG. 17 is a perspective view of another embodiment of soilless garden support.

FIG. 18 is a perspective view of the support illustrated in FIG. 17.

### DETAILED DESCRIPTION OF THE INVENTION

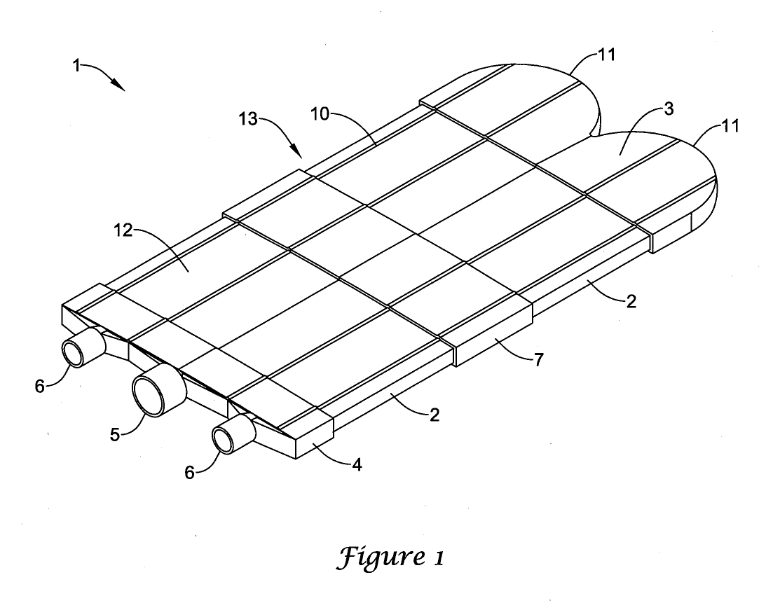

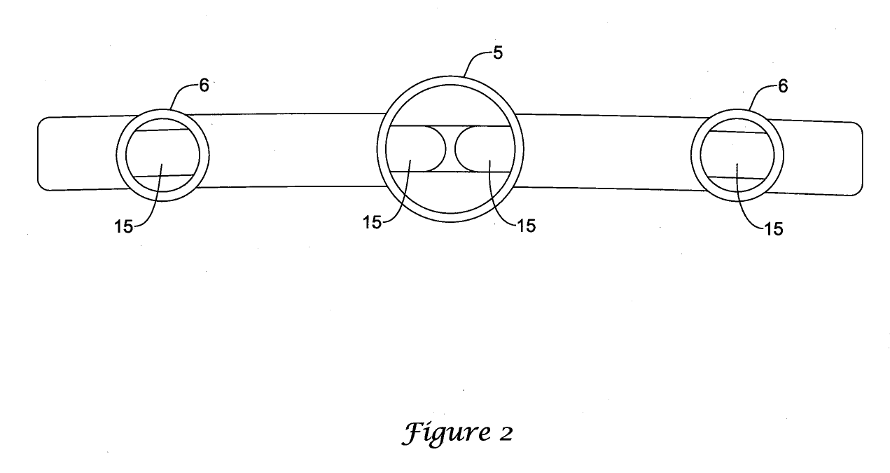

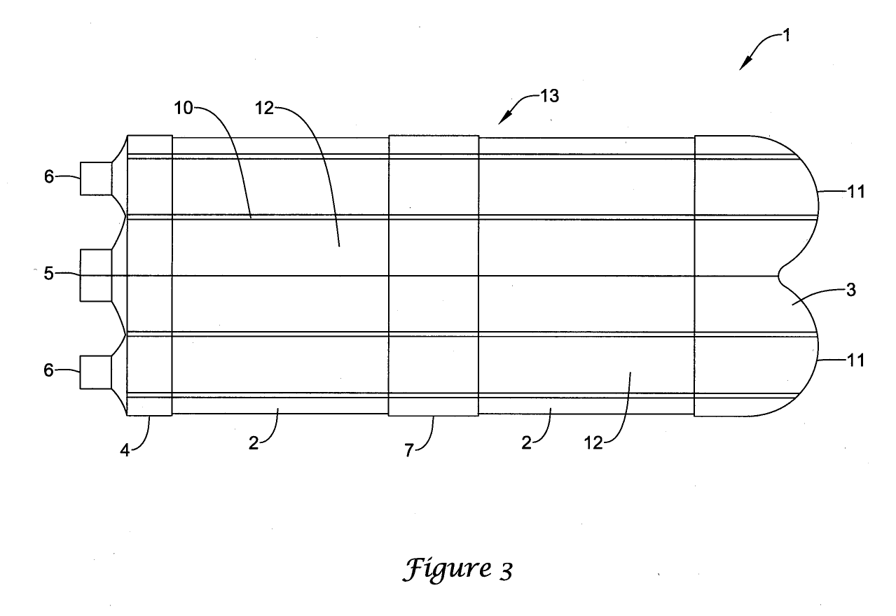

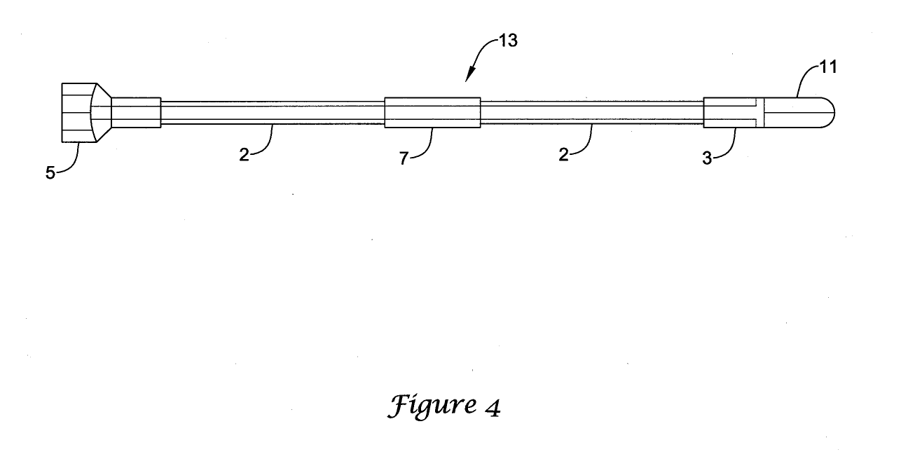

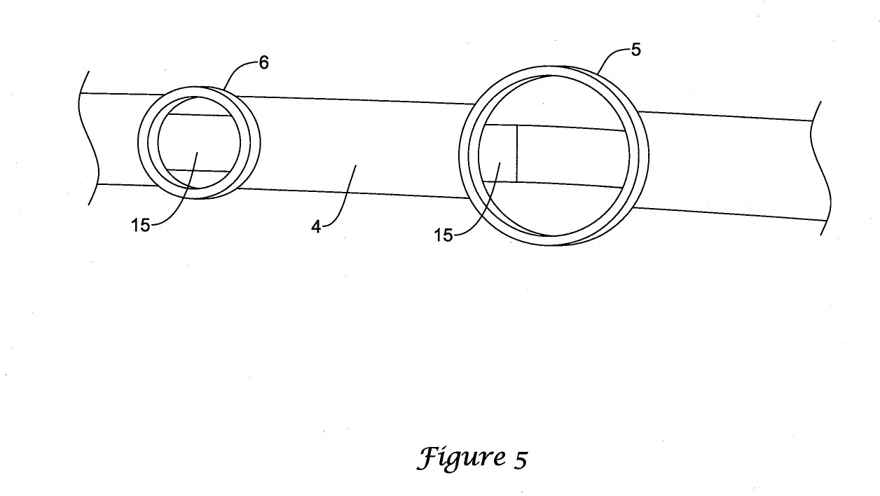

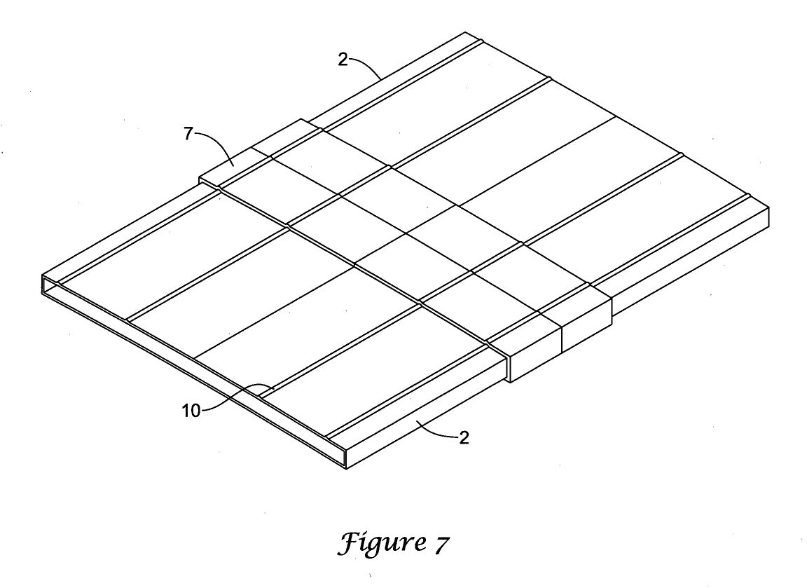

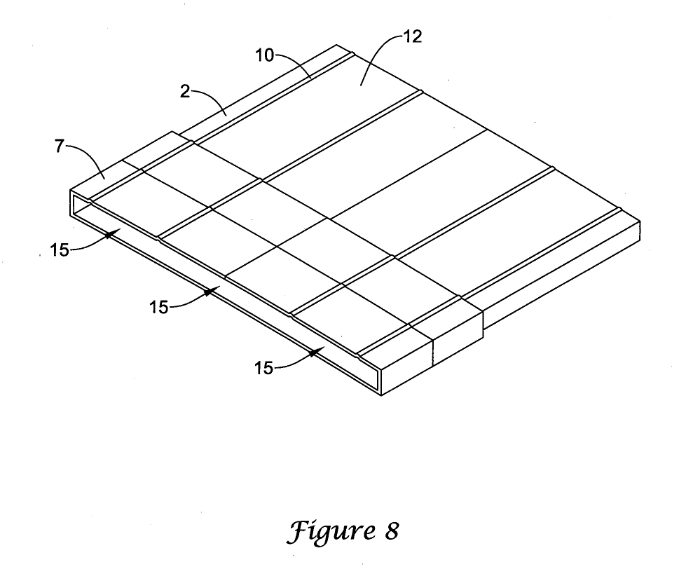

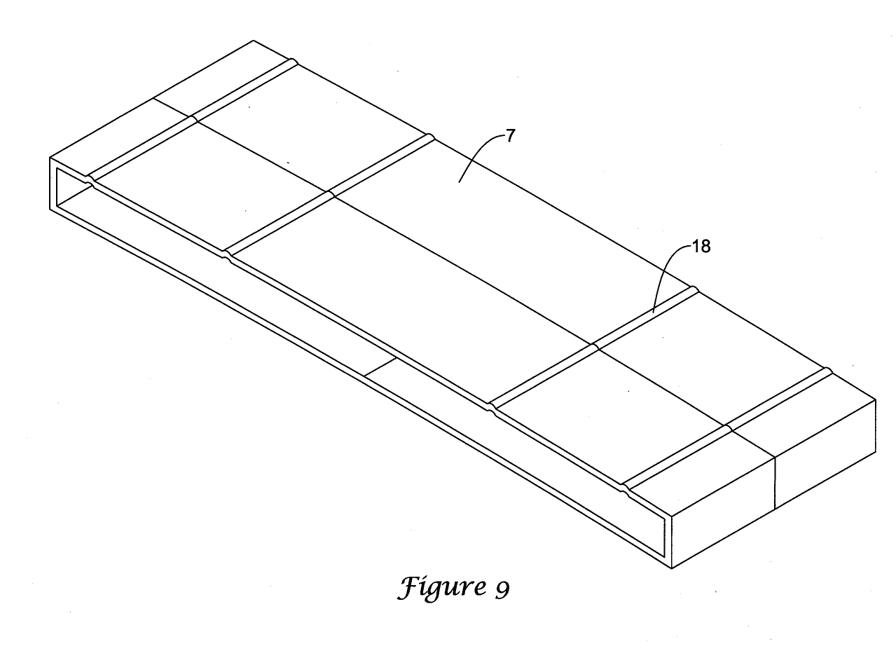

A modular soilless garden system is illustrated in FIGS. 1 to 10. The system 1 includes a platform 13 that supports a plant root host (such as a substratum mat). A subsurface fluid network extends below the platform 13 and facilitates the passage of fluid to regulate the temperature of the plant roots hosted in the cultivation medium.

The system 1 includes a plurality of foundations 2 that connect end to end to form the support platform 13. The platform 13 is formed from the upper surface 12 of each foundation 2. Networks of fluid passages 15 extend along the platform 13 below the supporting surface of each foundation 12. The individual fluid passages 15 that contribute to the fluid networks are integrated with each foundation 2. Two circulation manifolds 3, 4 connect to the terminal ends of the platform 13. The manifolds 3, 4 interconnect the distinct networks of fluid passages 15 to form a temperature regulating network that extends below the platform 13.

Each foundation 2 includes a support structure having opposed connecting ends. The connecting ends of the support structure facilitate interconnection with other components in the system (such as adjacent foundations 2 or the circulation manifolds 3, 4). Each support structure has an upper surface 12 that extends between the opposed connecting ends. The upper surface 12 of the foundations form the platform 13 when the system is assembled. The platform 13 supports the root host.

A plurality of distinct fluid passages 15 extend below the support surface of each foundation 2. The illustrated fluid passages 15 are integral with the foundation support structure. Each of the illustrated fluid passages 15 comprise an inlet and an outlet disposed at opposed connecting ends of the foundation 2. The inlet and the outlet are coupled by a lumen that extends along the length of the foundation 2. The lumen defines a sealed passageway between the inlet and the outlet, so that roots from plants being cultivated in the root host cannot penetrate the fluid passages. The fluid passages 15 of adjacent foundations 2 are interconnected when the platform 13 is assembled to form substantially sealed fluid networks. The networks of fluid passages extend along the platform 13 longitudinally. The fluid passages 15 allow fluid to be passed along the foundations of the platform 13 to regulate the temperature of the plant roots cultivated in the root host.

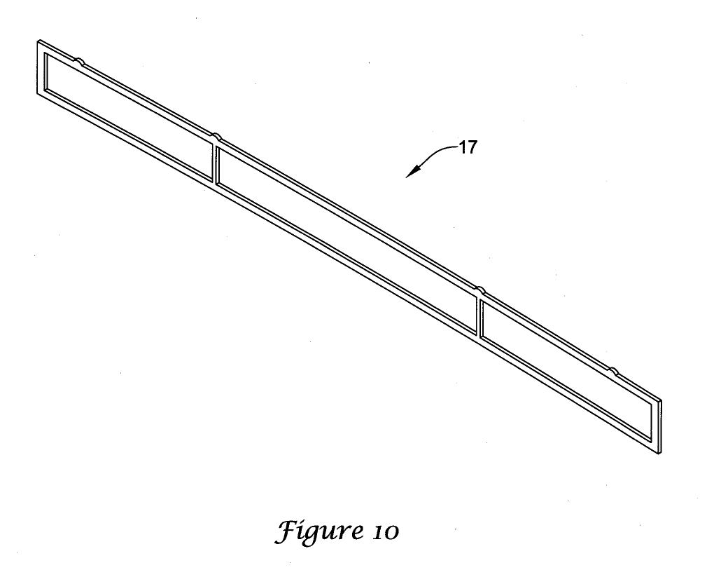

Adjacent foundations 2 may be connected together by a coupling sleeve 7. The illustrated coupling sleeve 7 overlaps and engages the adjacent foundations. The coupling sleeve 7 may also reinforce the platform 13. A gasket 17 (illustrated in FIG. 10) may be disposed within the coupling sleeve 7 to seal the junction between the respective fluid passages of the adjacent foundations. The coupling sleeve 7 and the connecting ends of the respective foundations 2 may be commensurately sized to produce a friction fit engagement, have reciprocal snap lock interfaces that facilitate a snap lock engagement or involve some other interlocking engagement. A plurality of notches 18 is disposed in the upper surface of the coupling sleeve 7. The notches accommodate the reinforcing ribs 10 that protrude above the upper surface 12 of the illustrated foundations 2.

Two circulation manifolds 3, 4 connect to the foundations disposed at opposing terminal ends of the platform 13. The manifolds 3, 4 interconnect the distinct networks of fluid passages that extend along the platform 13. The manifolds 3, 4 define an inlet and an outlet for the fluid network so that the platform 13 can be connected to an auxiliary temperature regulation system. The fluid network is substantially sealed between inlet and the outlet so that the roots of plants being cultivated on the support surface cannot penetrate the temperature regulation network.

The foundations 2 illustrated in FIGS. 1 to 10 are generally symmetrical about both longitudinal and transverse sections through the centre of mass. The support structure of each foundation 2 defines a rectangular, generally planar upper surface 12. The foundations 2 are arranged longitudinally end to end in the assembled platform 13, so that the supporting surface of the platform is also rectangular and generally planar. The width of the individual foundations 2 defines the width of the platform 13 in the illustrations. The length of the platform 13 is defined by the number of foundations 2 that are assembled end to end.

The fluid passages 15 are formed as cavities in the foundation support structure. The illustrated foundations 2 comprise three fluid passages. The cavities are arranged into a central fluid passage and two side fluid passages that flank the central passage on either transverse sides of the foundation 2. The fluid passage cavities extend along the length of the foundation and are arranged symmetrically below the upper surface 12.

The illustrated manifolds are divided into a distribution manifold 4 and a recirculation manifold 3. The distribution manifold 4 defines the inlet and the outlet for the system temperature regulation network. A single large bore opening 5 and two smaller bore openings 6 extend from a face of the manifold opposite the end foundation 2. The openings provide an inlet and an outlet to the temperature regulation network. The network configuration (choice of inlet and outlet) can be adjusted for particular applications. Here, the central large bore opening 5 is defined as an inlet and the smaller bore side openings are defined as outlets 6. In this situation, the large bore inlet 5 feeds fluid to the central fluid passage, and the two smaller bore outlets 6 disperse fluid from the two side passages that flank the central passage. The inlet 5 and the outlets 6 may be exchanged so that fluid enters the side passages and exits from the central passages. Other configurations are also possible.

The recirculation manifold 3 interconnects the distinct fluid passages at the opposing end of an assembled platform. The recirculation manifold 3 includes a plurality of ports that are arranged complimentarily with the foundation fluid passages. Each port is interconnected with another port by a recirculation line 11 to distribute fluid between the distinct fluid passages. The illustrated recirculation manifold 3 has a large bore inlet arranged to coincide with the central fluid passage and distribution manifold inlet. The large bore inlet feeds two recirculation lines 11 that diverge either side of the central fluid passage and re-circulate fluid along the side passages.

A plurality of reinforcing ribs 10 are illustrated protruding slightly above the generally planar upper surface 12 of each foundation 2. The reinforcing ribs 10 extend longitudinally along each foundation to strengthen the supporting surface of the platform and secure the supported root host. The upper surface 12 of the foundations 2 is preferably formed from a thin sheet of material (such as a suitable polymer or metal) to facilitate adequate heat transfer from the fluid passages to the root host, and as a result the supporting surface may require ribbing or other forms of structural reinforcing. Some of the illustrated reinforcing ribs 10 coincide with the division between fluid passages 15. It is also possible to introduce reinforcing around or within the fluid passages (such as networks of truss reinforcing).

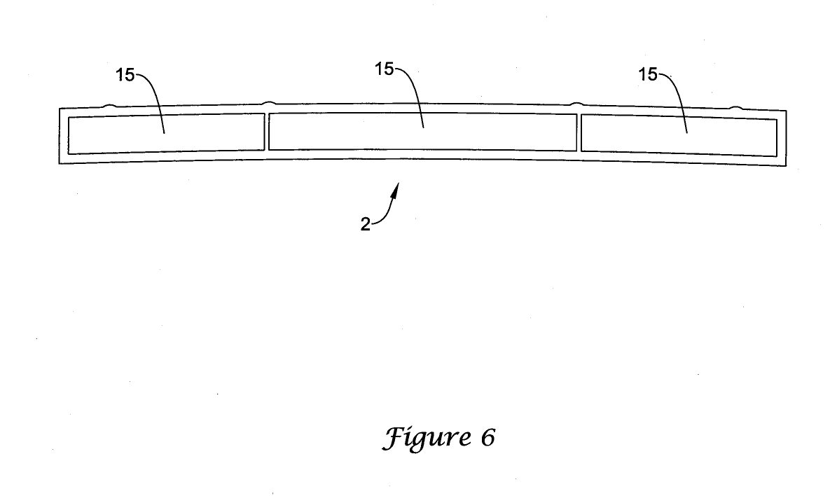

The upper surface 12 of the foundations 2 may also be slightly sloped. Where the upper surface is formed from a water impermeable layer, the slight slope of the surface can prevent pooling by directing excess nutrient solution from the platform toward drainage areas 3 (such as an outer edge of the platform). The upper surface 12 of the foundation 2 illustrated in FIG. 6 subsides gradually outward from the longitudinal axis toward the outer edges so that runoff is directed toward the sides of the platform 13. The upper surface 12 subsides evenly along the length of the illustrated foundation 2 producing a slight spine along the longitudinal axis. The foundation 2 may incorporate a drainage channel to collect runoff from the platform.

In other cases, the upper surface of the foundation may be perforated (such as a mesh skin over the foundation supporting structure) to facilitate drainage of nutrient solution through the foundation around the sealed lumen of the fluid passages.

The illustrated soilless garden system 1 allows the root temperature of plants cultivated in an associated root host to be more accurately regulated independent of the surrounding atmosphere (such as the ambient atmosphere of a soilless cultivation greenhouse). The root host medium is disposed on the support surface 12 of the platform 13 so that the platform and the root host medium are coupled by a thermal conduction pathway. The temperature of the support surface 12, root host medium, plant roots and any other components in the thermal conduction pathway between the fluid passages 15 and the plant roots is regulated by a fluid passed below the upper surface 12 of the platform 13.

The temperature regulating fluid is directed through the fluid passages 15 that extend below the support surface 15 of the platform 13. The fluid passages 15 are coupled to the upper surface of the platform by a thermal conduction pathway so that heat can transfer conductively between the plant roots and the temperature regulating fluid. The circulation manifolds 3, 4 allow the system to connect to an auxiliary temperature regulation system. The auxiliary system circulates a temperature regulated fluid through the fluid passages 15 of the platform 13. The temperature of the regulating fluid can be controlled based on the desired root temperature of the plants being cultivated. A suitable auxiliary temperature regulation system may measure the temperature of the root host medium and adjust the temperature of the regulating fluid (heat or cool) to compensate for deviations in the root host medium temperature from a desired temperature.

The auxiliary temperature regulation system may facilitate cooling and/or heating of the temperature regulating fluid depending on the particular application (the cultivation environment, the type of plant being cultivated and other considerations). The auxiliary temperature regulation system may incorporate active or passive temperature control, feedback based on measured root host temperature or basic mechanical thermostat temperature regulation.

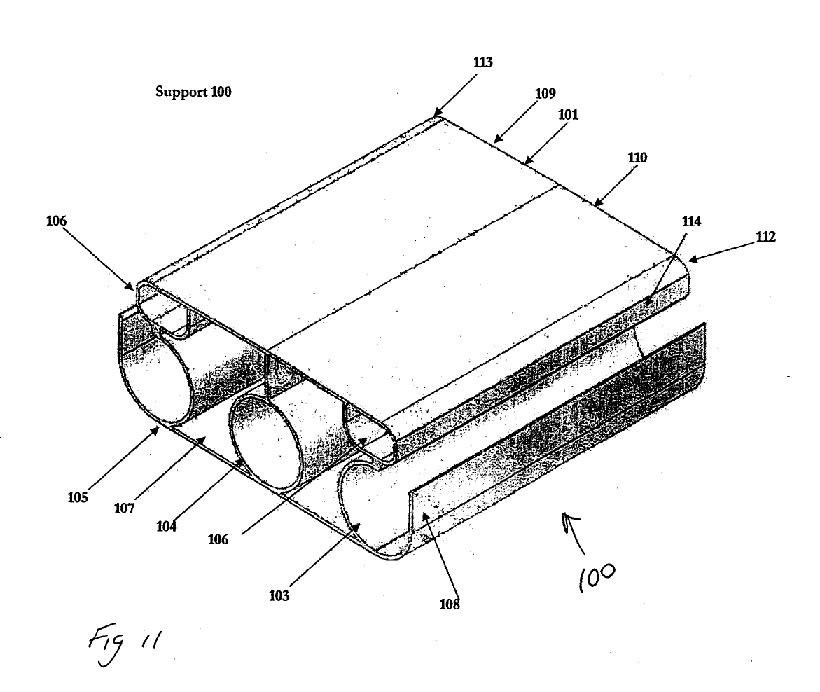

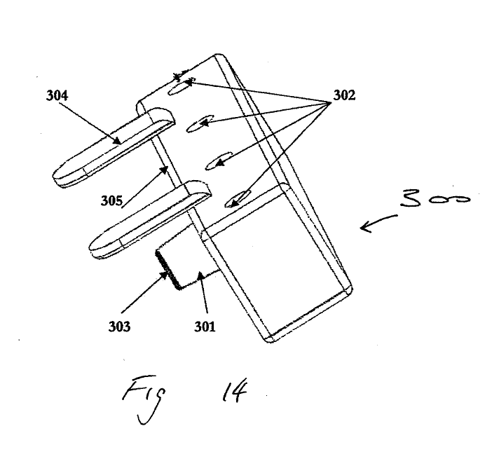

Variations of another soilless garden system are illustrated in FIGS. 11 to 18. Each of the illustrated systems includes a support for a root host (such as a substratum mat) with an integral drainage gutter disposed below the support surface to collect runoff.

The support 100 illustrated in FIG. 11 has a top surface 101 that is canted in both directions 109 and 110. The canted surface 101 promotes runoff of excess nutrient fluid. Two gutters 103 are disposed on either side of the support 100 below the top surface 101 to collect runoff.

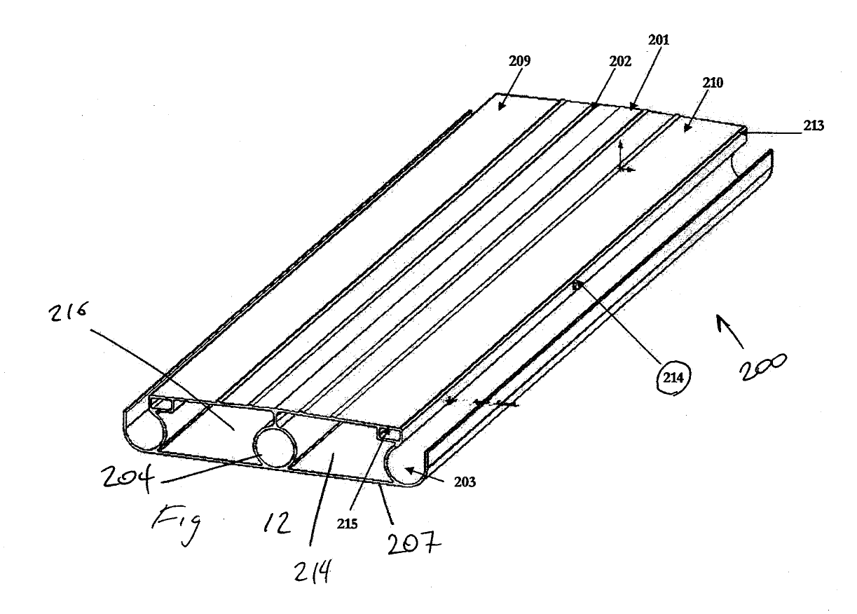

The support 200 illustrated in FIG. 12 has a similar configuration, but incorporates several ribs 202 on the top surface 201 that may be used to support and hold a substratum mat or another suitable root host. Again, the support's top surface 201 is canted in both directions 209 and 210 to permit runoff of fluid into the gutters 203. The support 200 illustrated in FIG. 12 has a greater width to height ratio than the support 100 illustrated in FIG. 11, which may be advantageous for certain plant varieties.

The support 200 also has a central passageway 204 and channels 214 or cavities 216 though which a fluid (such as air or water) may be pumped to regulate the temperature of the support, thereby either cooling or heating the root host disposed on the top surface 201 and the roots of the plants being cultivated. The distance between the root host and the system's bottom surface 207 and gutters 203 may be less than the average height of a root host (such as a substratum mat), reducing the center of gravity and providing better stability. The distance between the root host and the system's bottom surface 207 and gutters 203 may be approximately 3.5 inches, which has proved to be a workable size.

A feeding channel 215 is disposed at an outer edge of the support below the top surface 201. The feeding channel 215 carries a supply of nutrients in a fluid (either gas or liquid) to feed the plants being cultivated on the support 200. A plurality of holes 214 in the support 200 provide outlets to the nutrient channel 215 so that the nutrient fluid may be distributed to the plants.

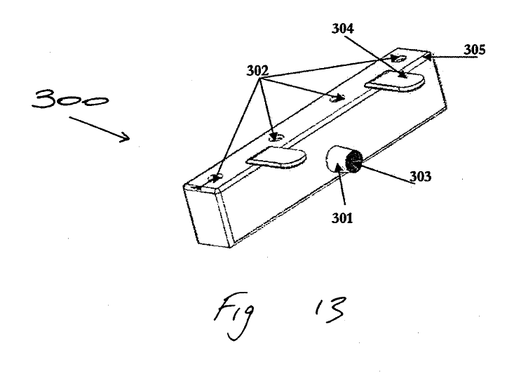

A nutrient distribution manifold 300 is illustrated in FIG. 13. The manifold 300 can connect to the support 200 to increase the number of feeding tubes supplied from a single outlet 214. An inlet 301 protrudes from the manifold. The inlet 301 connects to one of the holes 214 in the support through which the channel is accessible. The manifold 300 may have a screen or filter 303 adjacent the inlet 301 to prevent unwanted debris from entering the manifold. The illustrated manifold 300 has four outlets 302. Feeding tubes may be connected to each of the outlets 302 to distribute the nutrient fluid. The manifold 300 increases the feeding capacity of the support 200.

The illustrated manifold 300 has multiple tabs 304 disposed on a top surface. The tabs 304 rest on top of the support's top surface 201 to support the manifold 300 in position. A small gap may be defined between the manifold 300 and support 200 to allow runoff to drain into the gutters 203. The illustrated manifold 300 has a rounded outer edges 305 adjacent the top surface to direct runoff to the gutters.

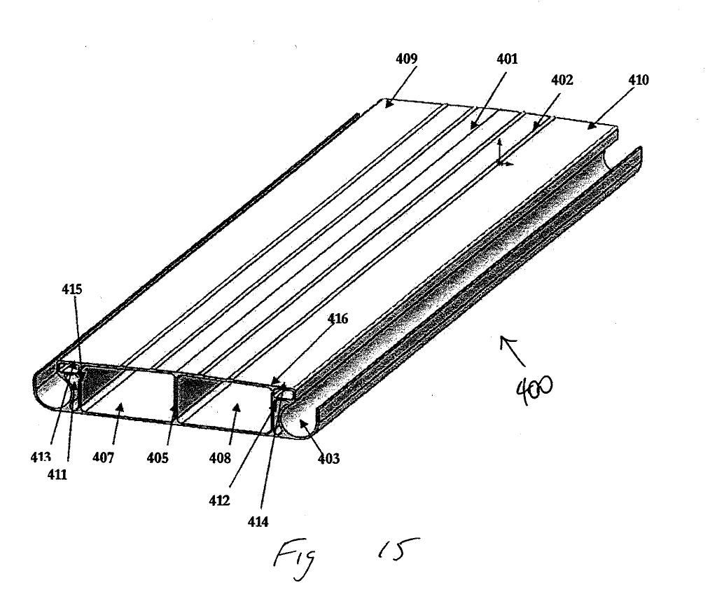

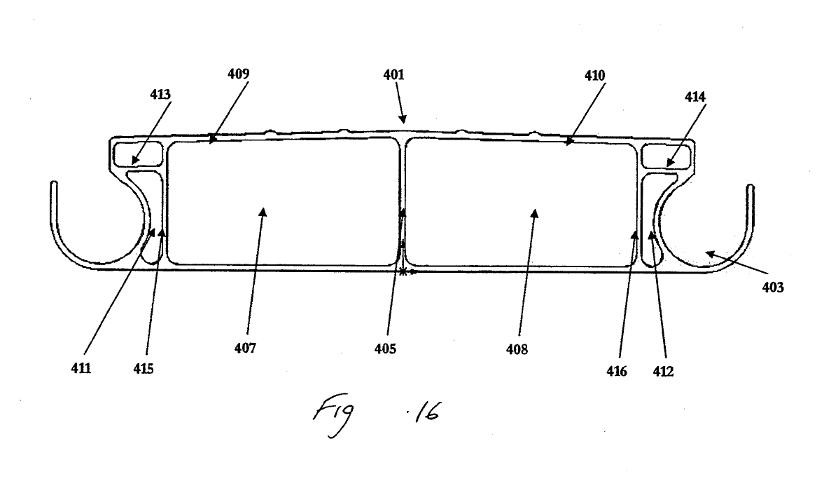

Another support 400 is illustrated in FIGS. 15 and 16. The top surface 401 of the support 400 has a plurality of protrusions 402 to hold a root host in place and a top surface 401 that is canted in both directions 409 and 410 to permit runoff to the gutters 403. The support 400 has a plurality of fluid passages 407, 408 disposed below the top surface 401. The fluid passages 407, 408 are formed in an internal cavity. The illustrated passages 407, 408 are separated by a divider 405. The divider 405 also reinforces the top surface 401 of the support 400

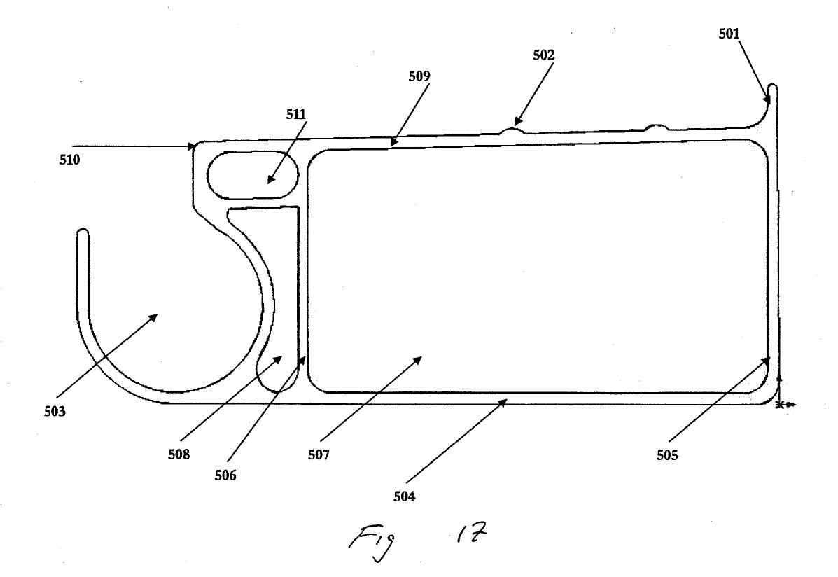

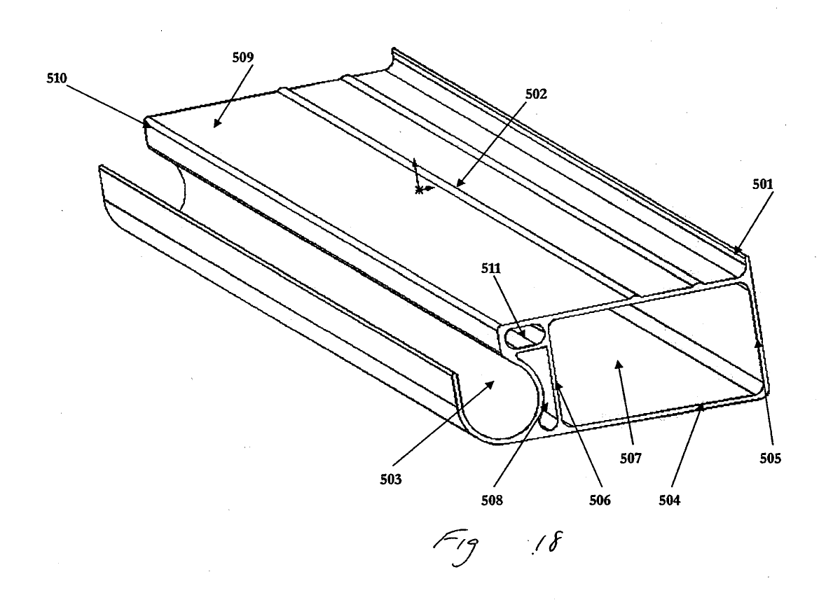

A single sided support 500 is illustrated in FIGS. 17 and 18. The illustrated support 500 is approximately half the width of the support 400 shown in FIGS. 15 and 16. The support 500 is intended for plants that require a reduced support area, such as pepper trees. The illustrated support 500 has an upright lip 501 that extends upwards beyond the top surface 509. The lip 501 assists retention of a root host medium. Feeding channels 511 and 508 extend along the support and may be used to supply nutrients or other materials to the plants. The gutters 503 run along the length of the support 500. The support's top surface 509 may be canted to permit runoff into the support's gutters 503.

The various soilless garden systems may be constructed from a suitable polymer such as PVC or other plastics, metallic sheet or a composite. External connectors on each support are provided so that a plurality of supports can be connected to one another to allow for mass production of plant breeding. The support may be extruded, cast, machined or otherwise constructed. In one embodiment, the support is extruded, and made from PVC, making it easier for installers to cut or glue together supports to create a continuous support of the desired length when installed onsite.

It will be appreciated that the above description relates to the preferred embodiments by way of example only. Many variations on the method and system for delivering the invention without departing from the spirit of same will be clear to those knowledgeable in the field, and such variations are within the scope of the invention as described and claimed, whether or not expressly described.

1. A modular soilless garden system comprising:
a plurality of foundations that connect end to end to form a support platform for a root host, each foundation comprising an upper surface that forms part of the support platform when assembled and a plurality of distinct fluid passages that extend between the connecting ends of each foundation and interconnect with the fluid passages of adjacent foundations when the system is assembled, the fluid passages being disposed below the upper surface of each foundation, and
two circulation manifolds that connect to opposing terminal ends of an assembled platform to interconnect the distinct fluid passages into a temperature regulation network, the manifolds defining an inlet and an outlet for the network that connects to an auxiliary temperature regulation system, the temperature regulation network being substantially sealed between inlet and the outlet.

2. The system of claim 1, wherein the fluid passages of each foundation are cavities in the support platform that extend along the length of the foundation between opposed connecting ends.

3. The system of claim 1, wherein one of the circulation manifolds is a distribution manifold that comprises a large bore inlet and two smaller bore outlets that connect the temperature regulation network of an assembled platform to an auxiliary temperature regulating system.

4. The system of claim 1, wherein one of the circulation manifolds is a recirculation manifold that interconnects the distinct fluid passages, the recirculation manifold comprising a plurality of ports that are arranged complimentarily with the foundation fluid passages, each port being interconnected with another port to distribute fluid between the distinct fluid passages.

5. The system of claim 1, further comprising a coupling sleeve that overlaps a junction created between adjacent foundations, the coupling sleeve engaging the respective foundations.

6. The system of claim 5, wherein the coupling sleeve and the connecting ends of the respective foundations are commensurately sized to produce a friction fit engagement.

7. The system of claim 5, wherein the coupling sleeve and the connecting ends of the respective foundations have reciprocal snap lock interfaces that facilitate a snap lock engagement.

8. The system of claim 5, wherein the coupling sleeve incorporates a gasket that substantially seals a junction between the fluid passages of adjacent foundations engaged by the connecting sleeve.

9. A soilless garden foundation comprising:
a support structure having opposed connecting ends that facilitate interconnection with other components of a soilless garden system, the support structure having a generally planar upper surface that extends between the opposed connecting ends to define a root host support, and
a plurality of fluid passages integral with the support structure, each fluid passage having an inlet disposed at one connecting end of the support structure, an outlet disposed at another connecting end of the support structure and a lumen that extends between the inlet and the outlet below the upper surface, the lumen defining a sealed passageway below the upper surface of the support structure between the inlet and the outlet.

10. The foundation of claim 9, wherein the upper surface of the support structure comprises a water impermeable layer that subsides toward a drainage area.

11. The foundation of claim 10, wherein the upper surface subsides to an outer edge of the support structure.

12. The foundation of claim 10, wherein the foundation comprises a drainage channel disposed below the upper surface of the supporting structure adjacent the drainage area to collect runoff from the foundation.

13. The foundation of claim 9, wherein the upper surface of the support structure is perforated to facilitate drainage of nutrient solution through the foundation around the sealed lumen of the fluid passages.

14. A method of regulating plant root temperature comprising:
hosting plant roots in an inert medium,
supporting the inert root host medium on a platform, the root host medium being disposed on a support surface of the platform so that the platform and the root host medium are coupled by a thermal conduction pathway,
passing a temperature regulating fluid below the upper surface of the platform, the temperature regulating fluid being directed through passages that are coupled to the upper surface of the platform by a thermal conduction pathway so that heat can transfer conductively between the plant roots and the temperature regulating fluid, and
regulating the fluid temperature based on the desired plant root temperature.

15. The method of claim 14, comprising measuring the temperature of the root host medium and adjusting the temperature of the regulating fluid to compensate for deviations in the root host medium temperature from a desired temperature.
